(19) United States
(12) Patent Application Publication
(10) Pub. No.: US 2018/0207667 A1
(43) Pub. Date: Jul. 26, 2018

(54) WATER CLEANOUT TOOL AND METHOD FOR FOAM GUN DISPENSER

(71) Applicants: Rohm and Haas Company, Collegeville, PA (US); Dow Global Technologies LLC, Midland, MI (US)

(72) Inventors: Marc S. Black, Midland, MI (US); Michael D. Bowe, Doylestown, PA (US); Michael F. Heckert, Lake Orion, MI (US); Matthew J. Turpin, Sanford, MI (US)

(21) Appl. No.: 15/745,473

(22) PCT Filed: Aug. 30, 2016
(86) PCT No.: PCT/US2016/049350

§ 371 Date: Jan. 17, 2018

Related U.S. Application Data
(60) Provisional application No. 62/213,150, filed on Sep. 2, 2015.

(51) Int. Cl. B05B 15/55; B08B 9/032

(52) U.S. Cl. CPC B05B 15/55; B05B 9/04; B08B 9/0325

(57) ABSTRACT

The present invention provides a cleanout adaptor (1) for a spray foam applicator equipped with a receiver basket (3) having a feed port (3b) adapted to receive an inlet source of foamable material, the cleanout adaptor having an open end that fits securely into the receiver basket, and the cleanout adaptor defining a fluid flow channel extending from the feed port to and securely connecting with a source of cleaner, such as water, for example, from a hose.

The present invention relates to reusable cleaning devices for spray foam applicators and to methods for using them that enables one to clean an aqueous or latex foam applicator with a single source of cleaner, without the use of solvents and without disassembly of the foam applicator. More particularly, it relates to a removable cleanout adaptor having an open end that fits securely into a receiver basket of a spray foam applicator having a feed port, the cleanout adaptor defining a fluid flow channel extending from the feed port to and securely connecting with a source of cleaner such as water, for example, a hose.

Foam sealants provide an increasingly popular way to improve the energy efficiency of buildings of all kinds, including homes. One component polyurethane foam sealants can be purchased in applicators like straw cans, or in cans which attach to a dispensing gun. So long as the sealant is kept in an airtight and water tight container, it can be re-used. If one wants to use a straw can a second time, the straws in the cans can be cleaned with organic solvents. Guns need to be cleaned before each use. To clean the internal parts of the gun, foam manufacturers also sell aerosol cans of gun cleaner solvent which can be attached to the gun to flush out uncured foam before it can harden and clog the gun. These cleaner solvents carry a flammability hazard and may be unsafe for use in the domestic setting. While one could alternatively disassemble the gun and clean the parts in solvent, this would be time consuming and risks errors, damage or loss of small parts during reassembly. Further, solvent cleaners are not useful for cleaning emulsion polymer (latex) foams, which can only be cleaned with water. Using an organic solvent to clean a latex foam applicator or gun would cause the latex to coagulate and thereby clog the gun.

U.S. Pat. No. 5,318,637, to Wernicke, discloses a method for cleaning urethane foam dispensers with heated water. In Wernicke, FIG. 2 is a top view of the foam dispensing gun. FIG. 5, FIG. 7 and FIG. 8 are cross sectional views. FIG. 5 and FIG. 7 show a threaded inlet port (36) for a cleaning composition. An external heat source would be needed to carry out the method in Wernicke; in addition, in the method, cleaning has to precede the curing of the resin and so has to be done quickly after use. Cleaning in such a manner may not even be possible in the case of a prolonged application. Finally, the device in Wernicke needs multiple ports for all of the inputs, leaving more parts that need to be maintained or that can break.

There remains a need for an effective method to clean out a spray applicator and its barrel with water after dispensing water borne foam materials.

The present inventors have sought to solve the problem of providing an effective and reusable cleaning device and method for using it that enables one to clean an aqueous or latex foam applicator.

### STATEMENT OF THE INVENTION

1. In accordance with the present invention, (i) a cleanout adapter for a spray foam applicator equipped with a receiver basket having a feed port adapted to receive an inlet source of foamable material, the cleanout adaptor having an open end that fits securely into the receiver basket, the cleanout adaptor defining a fluid flow channel extending from the feed port to and securely connecting with a source of cleaner, such as water, for example, a hose.

2. The cleanout adapter as in 1, above, wherein the (i) cleanout adapter has a male end that extends the fluid flow channel to the source of cleaner, which male end comprises a seal assembly around its periphery, such as any of an O-ring, washer, annulus, gasket, collar, cap, or any combination thereof, preferably, wherein the seal assembly comprises a rubbery or elastomeric polymer.

3. The cleanout adapter as in any of 1 or 2, above, wherein the (i) cleanout adapter is secured at its open end to the receiver basket of the spray foam applicator by (ii) a) a threaded collar which fits around the periphery of the cleanout adaptor and fits into a threaded female receiver basket or, b) in the case of a receiver basket that contains a female annulus, flange, O-ring, spring loaded ring or quick disconnect collar, for example, comprising a ball bearing housing wherein pulling on the collar will release the collar, that fits around the periphery of the cleanout adaptor at the open end a downstream male end on the cleanout adaptor that fits snugly into the corresponding female annulus, flange, O-ring, spring loaded ring or quick disconnect collar of the receiver basket.

4. The cleanout adapter as in 3, above, wherein, the (ii) a) threaded collar or b) downstream male end of the cleanout adaptor seats above a flange in the (i) cleanout adapter to secure the cleanout adapter into the receiver basket.

5. The cleanout adapter as in 3 or 4, above, wherein, the (ii) a) threaded collar and the (i) cleanout adapter are integrated into one piece that fits into a threaded female receiver basket.

6. The cleanout adaptor as in any of 2, 3, 4 or 5, above, wherein the (i) cleanout adaptor comprises at its male end a male snap or O-ring that fits a quick connect outlet that attaches and securely connects the cleanout adaptor to the end of a hose.

7. The cleanout adapter as in 6, above, wherein the male end of the (i) cleanout adaptor further comprises a male seal assembly, such as an elastomeric seal that fits into a hose or a source of cleaner.

8. A method for cleaning or using a spray foam applicator equipped with a receiver basket adapted to receive an inlet source of foamable material comprising, in any order, (i) securing the receiver basket of the spray foam applicator to an open end of a cleanout adapter that fits securely into the receiver basket, the cleanout adaptor defining a fluid flow channel extending from the open end to a male end adapted to attach securely to a source of cleaner, and (ii) connecting the male end of the cleanout adapter to the source of cleaner.

9. The method as in 8, above, wherein the (i) securing the receiver basket of the spray foam applicator to the cleanout adapter comprises placing around the male end of the cleanout adaptor a collar which fits around the periphery of the cleanout adaptor and has a connecting element so that the connecting element of the collar faces the open end of the cleanout adaptor and so that the collar contacts a flange at the open end of the cleanout adaptor, fitting the collar and cleanout adapter into the receiver basket, and attaching the collar to the receiver basket, wherein the connecting element is either a) a threaded collar that is threaded around its periphery and fits into a threaded female receiver basket or b), when the receiver basket comprises a female annulus or flange, O-ring, spring loaded ring or quick disconnect collar, a downstream male end that connects securely with and fits snugly into the corresponding female annulus, flange, O-ring, spring loaded ring or quick disconnect collar of the receiver basket.

10. The method as in 8 or 9, above, further comprising cleaning the spray foam applicator using cleaner from the source of cleaner.

11. The method as in 8, above, comprising prior to the (i) securing the receiver basket to the cleanout adaptor or subsequent any cleaning, (iii) attaching an inlet source, such as a can, of a foamable material to the receiver basket of the spray foam applicator, (iv) dispensing at least some of the foamable material through the spray form applicator, and (v) removing the can.

### BRIEF DESCRIPTION OF THE DRAWINGS

FIG. 1 illustrates an exploded view of the cleanout adapter, threaded collar, receiver basket and male seal assembly.

FIG. 2 illustrates a cleanout adaptor (1) of the present invention.

FIG. 3 illustrates a cut-away view of the cleanout adapter, threaded collar, receiver basket and male seal assembly as a single integrated device.

FIG. 4 illustrates a view of the cleanout adapter secured to a receiver basket, and in proximity to a source of cleaner (water) not (yet) attached to the male end of the clean out adapter.

The cleanout adapter of the present invention is reusable and is adapted to readily connect to a hose or other source of cleaning materials for use in cleaning foam applicators. The method for using the cleanout adaptor of the present invention enables the easy cleaning of spray foam applicators or foam guns using water borne materials; the method enables cleaning of the applicator with any source of water under gentle pressure. The cleanout adaptor avoids current practice in which such guns or spray foam applicators can only be cleaned with aerosol cans of solvent. The present invention encourages the use of latex foam sealants that are water soluble. Further, the cleanout adapter of the present invention can readily be molded as a single part.

In operation of the cleanout adaptor of the present invention, the open end of the cleanout adapter fits onto the inlet of a receiver basket on a spray foam applicator or foam gun. A source of cleaner, such as a hose for water, can be fitted to the other end (male end) of the cleanout adaptor to gently push the water through a check valve on the foam gun basket, into the gun body and barrel, and out of the dispensing tip. When the water flows clear, the foam gun is clean. One can optionally blow air through the foam gun to dry it.

The connections between the cleanout adaptor of the present invention and any foam gun receiver basket or source of cleaner must be capable of withstanding pressure great enough to open the check valve inside the feed port of the receiver basket. These check valves typically open at 0.8 bar of pressure.

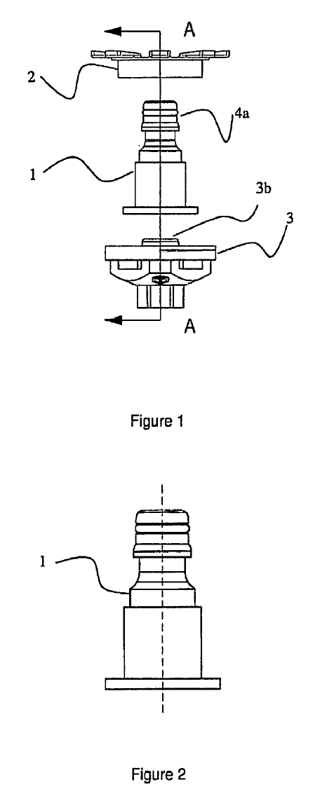

In a preferred cleanout adapter of FIG. 1, the cleanout adaptor (1) is secured to the receiver basket (3) of a foam gun (not shown) by a (female) threaded collar (2) (threading not shown), which seats above the flange of cleanout adapter (1), such that the open end of the cleanout adapter sealingly contacts with a feed port (3b) of the receiver basket.

Existing receiver basket adaptor threads are not designed to a specific thread standard. To enable easier use, the cleanout adapter of the present invention and a foam containing can male having a threaded adapter of top end of the can may both be threaded on the same receiver basket. However, if the threads of a receiver basket of a foam gun differ in thread size from the threaded collar, the cleanout adaptor can be fit with various threaded collars modified so as to fit multiple thread standards and receiver basket sizes. Thus, the cleanout adaptor of the present invention can come with multiple threaded collars to adapt to various foam guns.

Preferably, threaded collar (2. FIG. 1) has the same thread size as the collars on foam containing cans so that the cleanout adaptor and the foam containing cans can be alternately secured onto the receiver basket (3) of a foam gun (not shown) during use. FIG. 1 also shows an elastomeric seal assembly (4a) at the male end of cleanout adapter (1) to reduce the risk of water leakage.

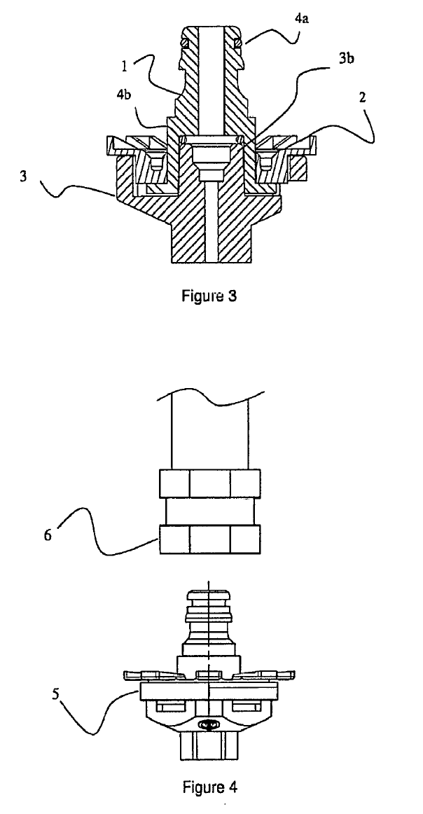

FIG. 3 shows an elastomeric O-ring seal assembly (4a) at the male end of cleanout adapter (1) connected via a collar (2) fitting around the cleanout adaptor (1) to the receiver basket (3) of a foam gun (not shown) to reduce the risk of water leakage. FIG. 3 also shows a second elastomeric O-ring seal assembly (4b) at the open end of cleanout adapter (1) where it contacts the feed port (3b) of the receiver basket (not labeled).

The cleanout adapter (1) of FIG. 2, shown with a flange at its open end and an elastomeric seal assembly, can be sized to receive as its connection to water a quick connect outlet from conventional garden irrigations systems, such as a hose.

In FIG. 4, cleanout adaptor (5) comprises an integrated or one piece design that can be molded as such so that the threaded collar (2) (FIG. 1) and the cleanout adaptor (1) (FIG. 1) comprises one and the same piece. Also shown is a source of cleaner (hose) (6) adapted to be connected to the male end of cleanout adaptor (5) (hose size not shown to scale). The end of the hose comprises a male hose thread (not shown) onto which a standard quick connect irrigation fitting has been screwed (quick connect mechanism not shown).

The cleanout adapter of the present invention can be connected to a foam gun by a threaded collar, or by another collar, such as, for example, a quick connect collar, such as an annulus or spring loaded ring, by a strap (not shown) which wraps around the foam gun, or by gentle hand pressure, or by friction.

To connect the cleanout adaptor of the present invention to a source of cleaner, a standard garden hose connection and or off the shelf quick connect fittings can be used. Such standard connections can comprise a female threaded collar around the male end of the cleanout adaptor that fits around the threaded end of a garden house, or standard pump type garden spray vessels. Not only is the open end threaded to fit into the receiver basket, but the male end is actually female threaded to screw on a garden hose directly.

A seal assembly may be present on the both the open end of the cleanout adaptor where it connects to the receiver basket and on its male end where it connects to the source of cleaner.

A seal assembly may be present only on the male end of the cleanout adaptor, or, where the threaded collar has a male end at its open end, the seal assembly may be present on both male ends of the cleanout adaptor.

Suitable seal assemblies can be any conventional device, such as an O-ring, gasket or washer, made from any sealing material, such as rubber.

The cleanout adapter of the present invention can be secured to the receiver basket of a spray foam applicator by either of a) a male threaded collar which fits around the periphery of the cleanout adaptor with the threaded end facing the receiver basket and that fits into a female threaded receiver basket or, b)) in the case of a receiver basket that contains a female annulus, flange, O-ring, spring loaded ring or quick disconnect collar that fits around the periphery of the cleanout adaptor at the open end having a downstream male end that fits snugly into the corresponding female annulus, flange, O-ring, spring loaded ring or quick disconnect collar of the receiver basket.

Where a (ii) collar is used to secure the cleanout adaptor into the receiver basket, the collar, threaded or otherwise, seats above a flange in the (i) cleanout adapter to secure the cleanout adapter into the receiver basket.

A seal assembly in the threaded collar or downstream male end of the cleanout adaptor may simply comprise a gasket against which the flange of the cleanout adaptor fits when it is connected to the spray foam applicator.

Preferably, the cleanout adapter of the present invention has at its male end a quick (dis)connect, such as a male O-ring, snap or annulus, that can be attached inside a garden hose or other source of cleaner; the same quick connect fitting snugly inside a source of cleaner. The source of cleaner can be adapted with a corresponding female fitting into which the male end quick connect fits snugly, for example, a female quick connect collar that screws onto the threaded male end of a hose.

Any source of cleaner that can clean latex may be used, such as, for example, water or water mixed with from 0.1 to 5 wt. % of a surfactant or dispersing agent. The only requirement of the source of cleaner or water source is that it be delivered at high enough pressure to overcome the check valve (not shown) pressure of about 600 mm/Hg (about 0.8 bar) on the receiver basket on the foam gun. Municipal household water is typically supplied at from 1140 to 2660 mm/Hg (1.5 to 3.5 bar) and is suitable for this purpose.

The cleanout adaptor of the present invention can be used with any spray foam applicator equipped with a receiver basket adapted to receive an inlet source of foamable material.

Suitable foam applicators or guns for use with the cleanout adaptor of the present invention include, for example, the gun for one-liquid injection disclosed in International Publication no. WO 01/26820A to Lee, the GS (Great Stuff™ sealant) Pro™ Series foam dispensing guns (The Dow Chemical Company, Midland, Mich.), a Handi Tool™ FT300 Dispensing Gun FOMO F61050 (Spray Foam Systems, LLC, Greensboro, Ga.), and Hilti Foam Dispensers, such as the Foam dispenser CF DS1 (Hilti Group, Schaan, LI).

The cleanout adaptor of the present invention advantageously allows for cleaning foam applicators like the Lee gun without disassembly of the gun; further, it allows for cleaning of any GS Pro™ gun without solvent.

The methods for using the cleanout adaptor of the present invention comprise securing the receiver basket of a spray foam applicator having a receiver basket to an open end of a cleanout adapter defining a fluid flow channel extending to a male end from the open end that fits securely into the receiver basket, and connecting the male end of the cleanout adapter to a source of cleaner.

In the methods of the present invention, securing the receiver basket of the spray foam applicator to the cleanout adapter comprises placing a collar over the male end of the cleanout adapter, fitting the male collar and cleanout adapter into the receiver basket, and attaching the collar to the receiver basket, wherein the collar is threaded around its periphery and fits into a threaded female receiver basket.

In alternative methods of the present invention, when the receiver basket of a foam applicator comprises a female annulus or flange, the collar of the cleanout adaptor comprises an O-ring, annulus, flange, or spring loaded ring around, its periphery that fits snugly into the female annulus or flange of the receiver basket.

### EXAMPLES

### Example 1

A cleanout adapter in accordance with FIG. 2, above, was produced on an Objet Connex 500 3-D printing system built by Stratasys (Eden Prairie, Minn.). The material used in printing the cleanout adapter prototype part was an ABS polymer material. The seal assemblies 4a and 4b (FIG. 3) are elastomeric O-rings. The threaded collar 2 (FIG. 1) is a standard threaded male collar used on aerosol foam cans, from the Pageris™ product line (C. Ehrensperger AD, Stäfa, CH).

We claim:

1. A cleanout adaptor for a spray foam applicator equipped with a receiver basket having a feed port adapted to receive an inlet source of foamable material, the (i) cleanout adaptor having an open end that fits securely into the receiver basket, the cleanout adaptor defining a fluid flow channel extending from the feed port to and securely connecting with a source of cleaner wherein the (i) cleanout adapter has a male end that extends the fluid flow channel to the source of cleaner and that has a female threaded collar around the male end of the cleanout adapter that fits around the threaded end of a garden hose directly.

2. (canceled)

3. The cleanout adapter as claimed in claim 1, wherein the (i) cleanout adapter is secured at its open end to the receiver basket of the spray foam applicator by (ii) a) a threaded collar which fits around the periphery of the cleanout adaptor and fits into a threaded female receiver basket or, b) in the case of a receiver basket that contains a female annulus, flange, 0-ring, spring loaded ring or quick disconnect collar that fits around the periphery of the cleanout adaptor at the open end, a downstream male end on the cleanout adaptor that fits snugly into the corresponding female annulus, flange, 0-ring, spring loaded ring or quick disconnect collar of the receiver basket.

4. The cleanout adapter as claimed in claim 3, wherein, the (ii) a) threaded collar or b) downstream male end of the cleanout adaptor seats above a flange in the (i) cleanout adapter to secure the cleanout adapter into the receiver basket.

5. The cleanout adapter as claimed in claim 3, comprising the threaded collar, wherein the (ii) a) threaded collar and the (i) cleanout adapter are integrated into one piece that fits into a threaded female receiver basket.

6. (canceled)

7. (canceled)

8. (canceled)

9. (canceled)

10. (canceled)
